(19) United States
(12) Patent Application Publication
(10) Pub. No.: US 2006/0048290 A1
(43) Pub. Date: Mar. 9, 2006

(54) Covets

(76) Inventor: Kathie Amy Francis, Miramar, FL (US)

Correspondence Address: KATHIE FRANCIS, P.O. BOX 55-1610, CAROL CITY, FL, 33055, US

(21) Appl. No.: 10/806,357

(22) Filed: Aug. 11, 2004

(51) Int. Cl. A41D 13/015; A62B 17/00

(52) U.S. Cl. 2/455

(57) ABSTRACT

I claim that COVETS, is the only product that would be offered to the public, in a variety of sizes for the hand, arm, foot, leg and torso, that has the ability to cover cast or bandages, and be submerged in water or liquid. It will seal out large amounts of water or liquids from coming in the open end. COVETS are the only ones offered in string or belt and come in water color such as blue, green, yellow, pink and red.

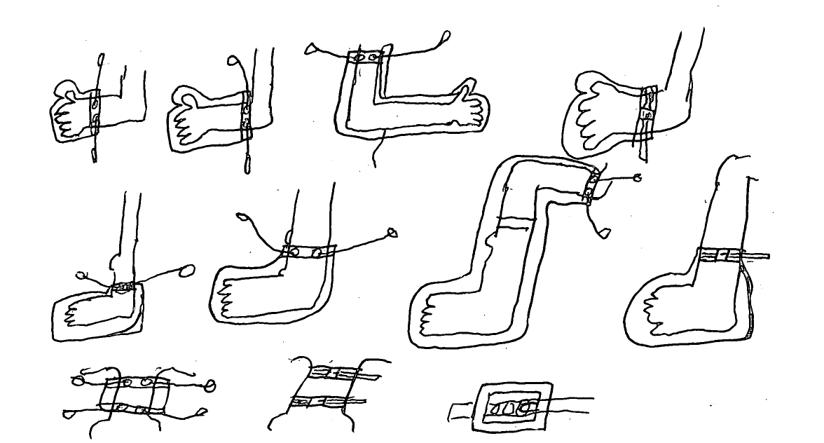

This is the specification, on how to make COVETS, using as an example the measurement of an adult between 5 feet and 5½ feet tall. There are multiple measurement for COVETS from infant size up to an adult 7 feet tall.

1. Take two pieces of clear poly plastic of 2 MIL for thin disposable COVETS or 10 MIL for the durable COVETS, place one sheet of the same plastic on top of each other and cut it in this fashion:

[image]

2. Heat seal or glue only (a. 20 inches), from top to bottom.

3. Open the (b. 22½ inches) and punch two ¼ inch size hole on one side, one inch apart, do this on the top and bottom.

4. Next take both b's top and bottom and fold them over one inch, and seal them by heat or glue.

5. Take two strings or and run them in the first hole until you get to the next hole at the top and do likewise at the bottom. Plastic belt may placed at the top by heat or glue instead of string.

I claim that COVETS are the only product that will be offered to the public in this from, width and length, such as been described, for all three body parts. There are three sizes foot to thigh, three sizes hand to shoulder and chest to waist COVETS. COVETS may be applicable in other areas, but it is mainly for protecting areas of enjury that maybe covered by a cast or bandage in a medical time, were in COVETS will protect that area from large protions of water or liquid in bathing or other situations.

1. I claim that COVETS will come in sizes for infant up to adults in different width and lengths to cover three body parts that are not on the market, in hand to wrist, hand to elbow, hand to shoulder and foot to ankle, foot to knee, foot to thigh and chest to waist.

2. I claim that COVETS will protect against large amount of water or liquids coming from the outside into the COVETS when used properly and fitted for the right sizes person. The chest to waist MAY need when applicable, the use of a tape, such as paper tape at the mid front and or back, depending on the body shape.

3. I claim that COVETS are safe when used properly and by adults.
